(19) United States
(12) Patent Application Publication
(10) Pub. No.: US 2025/0307872 A1
(43) Pub. Date: Oct. 2, 2025

(54) Digital Content Creation With Dynamic Targeting

(71) Applicant: Google LLC, Mountain View, CA (US)

(72) Inventors: Paul Kenjora, Tiburon, CA (US); Ana Lucero Esqueda Rocha, San Francisco, CA (US); Davesh Bhambey, Fremont, CA (US); Djimbaye Andemel, Antioch, CA (US); Sanket Chandrakant Sable, San Jose, CA (US)

(21) Appl. No.: 19/078,686

(22) Filed: Mar. 13, 2025

Related U.S. Application Data
(60) Provisional application No. 63/570,421, filed on Mar. 27, 2024.

(51) Int. Cl. G06Q 30/0251; G06Q 30/0241

(52) U.S. Cl. CPC G06Q 30/0251; G06Q 30/0276

(57) ABSTRACT

Methods, systems, and apparatus, including computer-readable storage media for generating model-generated digital content from prompts built using a combination of a base object description and targeting parameters for an intended audience. The digital content, once generated, can be served to a target audience indicated by the targeting parameters. A system implementing the methods described herein can generate content for various different audiences, indicated by different combinations of targeting parameters available on a campaign management platform serving the content. When the content is no longer being served the system can cause the digital content to be deleted or otherwise discarded. Instead of storing the content, the system can save the prompt and re-process the prompt through the model to re-generate the content. The system can further index prompts for later querying, so that the system can avoid generating new prompts over using stored prompts for content generation.

### CROSS-REFERENCE TO RELATED APPLICATION

The present application claims the benefit of the filing date of U.S. Provisional Patent Application No. 63/570,421, filed Mar. 27, 2024, the disclosure of which is hereby incorporated herein by reference.

### BACKGROUND

A campaign management platform manages and serves digital content to user computing devices of users forming part of an audience of computing devices targeted for receiving the digital content. Targeting parameters within the platform can specify different characteristics of a desired audience, for example, based on the audience's geographic location, demographics of users interacting with the devices, or means of requesting content, such as through a mobile device or a personal computer. Within a campaign, different content items are provided to the platform for serving to computing devices according to different conditions, including different targeting parameters. A flight of content is served, for a period of time, to user computing devices of an audience indicated by the targeting parameters.

Campaign management platforms offer dozens, hundreds, or more of individual targeting parameters, with permutations of these parameters reaching millions or billions of combinations. Further, specific digital content items, such as text, images, or videos, may be set to be served according to specific combinations of these targeting parameters. Each of these content items is stored and served to computing devices of users within audiences targeted by these different parameter value combinations. Campaign management platforms may often serve the same or similar content to the same audiences at different points in time, e.g., on a seasonal, yearly, or other periodic basis.

### BRIEF SUMMARY

Aspects of the disclosure relate to methods for generating digital content from prompts to artificial intelligence (AI) models that are generated using a combination of a base object description and targeting parameters for an intended audience of computing devices. A system implementing the methods described herein can generate content for various different audiences, indicated by different combinations of targeting parameters available on a campaign management platform serving the content. When the content is no longer to be served, e.g., at the expiration of a flight indicating a period of time during which the content is to be provided to user computing devices, the system can cause the digital content to be deleted. Instead of storing the content, the system can save the prompt and re-process the prompt through the model to re-generate the content. The system can further index prompts for later querying so that the system can avoid generating new prompts over using stored prompts for content generation. The term prompt is used interchangeably with the term natural language prompt herein.

Other implementations of this and other aspects include corresponding computer systems, apparatus, and computer programs recorded on one or more computer storage devices, each configured to perform the actions or operations of the methods.

### BRIEF DESCRIPTION OF THE DRAWINGS

FIG. 1 is a block diagram of an example digital content generation system in communication with a campaign management platform, according to aspects of the disclosure.

FIG. 2 depicts a flow diagram of an example process for generating digital content, according to aspects of the disclosure.

FIG. 3 depicts a flow diagram of an example process for generating a prompt for a generative model trained to generate digital content, according to aspects of the disclosure.

FIG. 4 is a block diagram illustrating one or more models, such as for deployment in a datacenter housing one or more hardware accelerators on which the deployed models will execute for generating digital content according to prompts generated and stored in accordance with aspects of the disclosure.

FIG. 5 is a block diagram of an example computing environment for implementing the digital content generation system.

### DETAILED DESCRIPTION

### Overview

Aspects of the disclosure relate to a system for dynamically generating artificial intelligence (AI) model-generated digital content from prompts built using a combination of a base object description and targeting parameters for an intended audience served the content. A base object description is data at least partially characterizing or describing a base object, such as a topic, product, or service that is the subject of digital content to be generated. Targeting parameters at least partially characterize the audience intended for receiving the digital content.

The digital content, once generated, can be served to a target audience of computing devices indicated by the targeting parameters. The system can generate prompts for content for various audiences, indicated by different combinations of values of targeting parameters available on the system or on a campaign management platform serving the content. When the content is no longer to be served, e.g., at the expiration of a flight indicating a period of time to serve the content, the system can cause the digital content to be deleted or otherwise discarded. Instead of storing the content, the system can save the prompt and re-process the prompt through the model to re-generate the content. The system can further index prompts for later querying, so that the system can avoid generating new prompts over using stored prompts for content generation.

Digital content is often served multiple times to a target audience, e.g., as different flights of a campaign to provide content to user computing devices of a target audience. Aspects of the disclosure provide for generating prompts automatically, using information that is already present for other purposes, e.g., for managing a campaign of digital content serving to a target audience of devices. Instead of relying on manually-generated prompts, the system can pre-emptively generate prompts using a base description of the object that is the subject of the digital content, and different permutations of values for targeting parameters. For example, a targeting parameter can be “geographic location,” while a value for the parameter can be “San Francisco.” Values can also be numerical values or ranges. The variation from different user input prompts allows for the generation of consistently formatted prompts, which can facilitate efficient retrieval of the prompts for later use once stored and can be used to replace or reduce the need to store digital content for reuse.

By generating and storing prompts, the system can save processing time and resources from redundant generation of the same prompts. By storing prompts and discarding the content items after the content items are no longer to be served, the system can reduce the overall storage needed for data needed to later retrieve the content items. While a prompt may be a string of text on the order of kilobytes in length, the content items may be images or video of varying resolutions, which may require megabytes of storage to save to memory.

Even if the prompt to generate a new digital content item is not exactly the same as what is already stored, earlier prompts that the system identifies as similar to the more recently received prompt to generate the new content item can be queried and retrieved for use as a base template. The system can adapt the queried prompt to match the most recently received query, e.g., by modifying the base object description or target parameter values associated with the desired content item. This retrieval and modification further reduce the possibility of redundant computation that would otherwise be performed if the prompt were instead re-generated.

To facilitate retrieval of digital content from saved prompts, the generative model trained to generate the content from the prompts can be configured to deterministically re-create the same output from the same input. This can be achieved, for example, by training the model to generate the same output for the same prompt received at different points. As another example, model execution can include a versioning system, in which a prompt includes a version number of the model. The system can use the version number to select a version of the model for generating content from the prompt.

For different combinations of targeting parameters and a base object description, the system can generate a prompt for a generative model to generate content responsive to the audience indicated by the targeting parameters. This generation can be performed prior to any request received by the system for content, to pre-emptively build a library of model prompts for content.

For example, if the targeting parameters include parameters for targeting devices in different geographic locations, the system can generate multiple prompts using the base objection description and different possible values for the geographic locations. When a request is received for generating content related to the base object description and the geographic location indicated by parameter values in the request, the system can retrieve the pre-generated prompt and generate the digital content using the trained generative model. The system trades storing images, video, and other multimedia content, with smaller text prompts and additional processing by a model receiving the prompt as input. As audience targeting may require multiple different targeting parameters, and each parameter may have multiple different possible values, the total combination of possible audiences and storing digital content tailor-made for each audience can become the bottleneck to a system required to save and serve the content.

Generating prompts for all possible combinations of targeting parameters may not always be desired, for example, because certain targeting parameters may be more relevant. Relevancy may be user-determined or determined by the system. For example, the system may prioritize the use of different values of targeting parameters. The prioritization applied can be determined, for example, based on the type of digital content to be generated, e.g., text or text-based content, video, image, or audio. For example, the values can be weighted when provided as input to a prompt generation engine, based on the applicability of some targeting parameters over others. The system can monitor which targeting parameters are used most often for targeting a respective audience and generate prompts from permuted values of those parameters.

The system can also receive additional input including criteria or limitations on digital content generated. For example, the input can include positive or negative keywords to include or exclude from the digital content. As another example, the input can specify the use or prohibition of certain backgrounds for the digital content. These criteria or conditions can be provided directly to the system through additional user input. These criteria or conditions can also be provided indirectly to the system through a corresponding set of targeting parameter values that result in the system generating content adhering to the provided criteria.

For example, one criterion to the system can be to not use city backgrounds. The system can either receive additional input for processing through a generative model specifying not to use this type of background. The system can also receive targeting parameter values for a geography targeting parameter that includes only rural, suburban, and/or nature-based values. The system generates digital content items that vary for different targeting parameter values, but stays within one of the predetermined values for the geography targeting parameter.

Although aspects of the technology are described with reference to generating, storing, and later retrieving prompts, the system can also be configured to generate, store, and retrieve base templates for generating different prompts based on a base object description and combinations of targeting parameter values. In this regard, a template may refer to a portion of a natural language prompt that describes the base object and a set of targeting parameter values selected to form part of a prompt for generating digital content direct to the base object. The template can be represented as a logical proposition, a function, or a predetermined set of keywords or other text encoding parts of the base object description and selected values of targeting parameter values.

To complete the template, the system can insert targeting parameter values corresponding to targeting parameters referenced in the template. For example, a template may have a subset of all targeting parameters listed, which the system can fill in with specific values corresponding to the parameters.

In some examples, the model can generate digital content for different combinations of targeting parameter values and the same base object description. The model is trained to then select one or some of the digital content items from the different digital content generated according to the different combinations.

### Example Systems

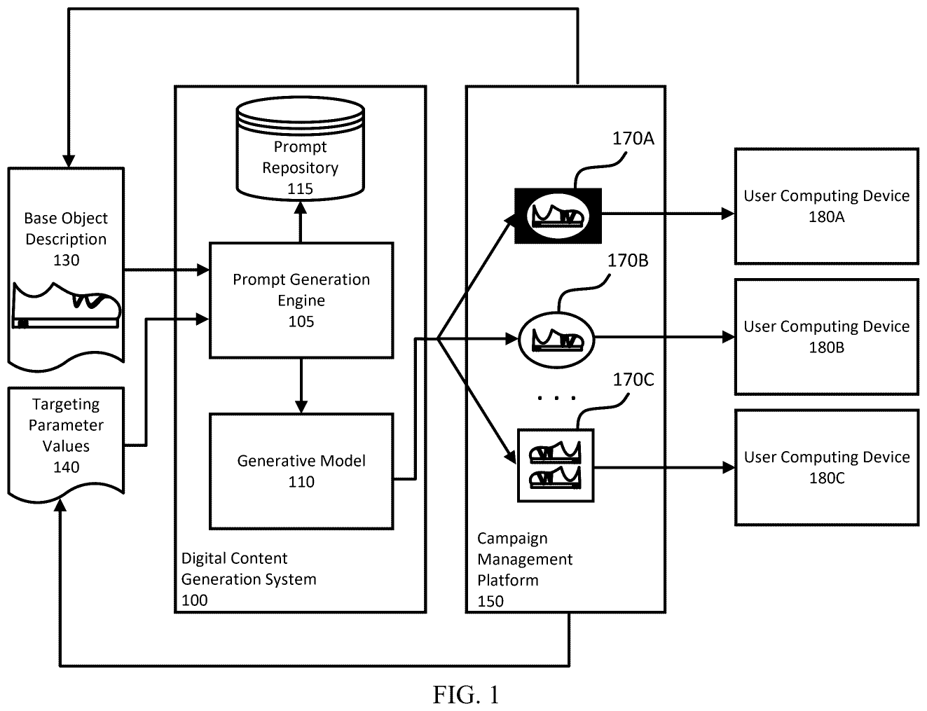

FIG. 1 is a block diagram of an example digital content generation system 100 in communication with a campaign management platform 150, according to aspects of the disclosure. In some examples, the system 100 and the campaign management platform 150 can be part of a larger system, while in other examples, the system 100 and the platform 150 are implemented on separate devices in one or more physical locations.

The system 100 and the platform 150 can be in communication over a network. In some examples, the system 100 does not communicate with a campaign management platform, and instead receives input and generates output in direct communication with user computing devices 180A, 180B, and 180C. Some or all of the data forming the base object description 130 and the targeting parameter values 140 can be received by the engine 105 through the platform 150. In some examples, the system 100 is configured to perform some or all of the operations or components described as performed by the campaign management platform 150.

The platform 150 may be configured to manage the serving of content to user computing devices 180A, 180A, and 180C, and provide a user interface for doing so. For example, the user interface can be configured as a web interface, an application programming interface (API), a standalone software application, etc., for organizing and causing digital content to be served to different user computing devices in accordance with different targeting parameters.

Content delivery may be organized as one or more campaigns, each campaign logically associated with some subject content. Campaigns may be further subdivided into groups, representing potential variations on the type of content to be served. Groups may be further subdivided into line items, representing even more specificity in the digital content to be served, the time at which to serve the content, and/or the computing devices that are a target of the content. The time at which to serve the content corresponds to the flight for the content. Digital content, the period of time at which the digital content is to be served to different user computing devices, and/or targeting parameters for selecting which user computing devices to serve the content to may be selected at either the campaign, group, or line item level.

After the platform 150 receives the content, a flight for the content, and targeting parameters for the computing devices to serve the content, the platform 150 is configured to serve the content to the user computing devices 180A-C. The flight may be as short as the time it takes to send the content to the user computing devices 180A-C. In other examples, the flight may be any length of time, such as hours, days, weeks, and so on. Serving the content can include sending the content over a network to be displayed or outputted by the devices, or causing content stored on the user computing devices to be displayed or otherwise outputted.

The system 100 includes a prompt generation engine 105, a generative model 110, and a prompt repository 115, which can be implemented, in different examples, on one or more computing devices in one or more physical locations. The prompt generation engine 105 is configured to generate natural language prompts from a base object description 130 and targeting parameter values 140. The base object description 130 and/or the targeting parameter values 140 can be retrieved through an interface, for example an API or standalone software application configured to retrieve the description and/or values from a source, such as a database or other repository. In some examples, the data is retrieved from the platform 150, as shown in FIG. 1.

The base object description 130 is data at least partially characterizing the base object, which can be, for example, a topic, good, service, etc., that is the subject of digital content to be generated. For example, a base object may be a product, and the base object description 130 can include the name of the product, a description of the product, keywords related to the product, and so on. In some examples, the base object description 130 can include a model representation of a base object. In such an example, the model representation of the base object may be a composite or series of photos or as data representing a computer drawing or a multi-dimensional model of the base object, such as a two-dimensional model or a three-dimensional model. The base object description 130 can include natural language, tags, titles, etc. The system 100 can automatically retrieve components of the base object description 130 or the base object description 130 from different sources, including the campaign management platform 150 and from user input.

The base object description 130 can include data of different modalities, such as, images, video, computer drawings, audio, text, and so on. For example, the base object description 130 can include a text description of the base object, the name of the base object, and images or videos of the base object in some context.

The prompt generation engine 105 also receives targeting parameter values 140 for one or more targeting parameters. Targeting parameters at least partially characterize the audience intended for receiving the digital content. Example parameters can include geographic locations and temporal ranges, specifying where and when digital content is requested by different computing devices. The targeting parameters can include parameters targeting specific types of operating systems for computing devices or types of computing devices for serving digital content to, such as laptops, mobile phones, video game consoles, televisions, and so on. Other examples include what types of websites or webpages are accessed when a digital content request is made. Other examples of targeting parameters include characteristics of users predicted or predetermined to interact with input and output of a computing device.

Other example parameters can include parameters related to a description or characterization of users of computing devices or consumers of digital content served through the computing devices. Either the system 100 or the platform 150 can track and tag computing devices according to these parameters, which can include age or age ranges, or whether a user or consumer is deemed to be high value, disengaged, etc. Targeting parameter values 140 can be represented in various different formats, including numerical formats, categorical formats, textual formats, or other computer-readable formats. For example, the parameter values 140 can include strings of text, numbers, or selections from a predetermined list of values for a given parameter. The targeting parameters can include any combination of parameters offered by a campaign management platform for serving digital content according to audiences indicated by the parameters. The targeting parameter values 140 may include different permutations of the targeting parameters. For example, if there are three targeting parameters, each with three values, then the targeting parameter values 140 may include twenty-seven (3×3×3) sets of values for the parameters.

At least some of the targeting parameter values 140 can be provided as user input or as input to the system 100 or the platform 150. While the platform 150 may already be configured to target audiences in accordance with a predetermined set of targeting parameters, the platform 150 may also receive additional targeting parameters and possible values for those parameters. The system 100 can receive those additional targeting parameters from the platform 150 or as direct input from another computing device.

The system 100 can retrieve all or some of the possible targeting parameter values and store the values in a database or other data structure. In some examples, the prompt generation engine 105 only receives subsets of possible parameter values. The subset may be determined by input received by the system 100 or the platform 150. For example, the campaign management platform 150 may receive user input indicating combinations of parameter values for generating digital content. The system 100 receives only the user-inputted combinations. Targeting parameter values may include default or empty values, for example to function as a placeholder or default for when a set of received values does not include a value for one or more of the targeting parameters.

In some examples, the system 100 receives subsets of combinations weighted according to various different factors. The different factors can include how often a targeting parameter, or combination of targeting parameters, is used for defining an audience to serve digital content to, parameters that are more likely to be used for digital content of different modalities or based on other factors that the system 100 is predetermined to use in determining different combinations of targeting parameters for prompt generation. Some targeting parameters can be prioritized or de-prioritized, based on, for example, user input or based on information indicating how often the targeting parameters are used in targeting an audience for serving content by the platform 150.

The system 100 can be configured to generate, store, and retrieve base templates for generating different prompts based on a base object description and subsets of combinations of targeting parameter values. In this regard, a template may refer to a portion of a natural language prompt that describes the base object and a set of targeting parameter values selected to form part of a prompt for generating digital content direct to the base object. The template can be a logical proposition, a function, or a predetermined set of keywords or other text encoding parts of the base object description and selected values of targeting parameter values

The prompt generation engine 105 generates prompts using the base object description 130 and the targeting parameter values 140. The engine 105 can translate some or all parameter values from a computer-readable data type, e.g., enums, encoded bytes, etc., to a natural language equivalent for inclusion in a prompt. The engine 105 combines the base objection description 130 and the targeting parameter values 140 into a prompt, for example by concatenating text and including descriptions of non-text modalities, such as metadata annotations of images or videos provided as part of the base object description 130.

The prompts generated by the engine 105 can also indicate in what form the content is to be generated. The modality of the digital content may be predetermined or received as additional input by the engine 105. For example, the prompt may specify that the digital content be generated in the form of images, text, audio, or video. In some examples, the generative model 110 is pre-trained for generating digital content according to a specific modality.

The prompt can include a combination of natural language text structured according to various formats. For example, the prompt can be structured as a query, such as according to SQL or another predetermined format. The prompt may be entirely in natural language, such as in sentences, bullet points, paragraphs, or other propositions, commands, questions, or requests. The engine 105 can also generate portions of a prompt according to these techniques, for example for use in completing a prompt using the template or portion.

In examples in which the system 100 generates, stores, and later retrieves templates or portions of a prompt, the engine 105 can use the template or portion as input for generating a complete prompt, which may also include any additional input such a base object description and/or targeting parameter values not already represented in the template. To complete the template, the system can insert targeting parameter values corresponding to targeting parameters referenced in the template. For example, a template may have a subset of all targeting parameters listed, which the system can fill in with specific values corresponding to the parameters.

After generating the prompt, the engine 105 can cause the generated prompt to be stored in the prompt repository 115. The repository can store prompts indexed according to the base object description 130 and/or the targeting parameter values 140 used to generate a respective prompt. Instead of generating a new prompt, an existing prompt can be used and modified by the engine 105, for example to adjust for different targeting parameter values with the same base object description. The system can more efficiently generate prompts, particularly at scale, by re-using or modifying existing prompts, instead of generating new prompts each time, which may be entirely or largely redundant to previously generated prompts. The engine 105 may overwrite existing prompts, for example that were also generated from the same base object description and targeting parameter values, thereby saving storage space by avoiding saving redundant prompts.

Generated templates or portions of prompts may also be stored. Storing at least a portion of a prompt can also improve the efficiency of the system, at least because the template or portion can be added directly to a complete prompt instead of re-generating each time digital content for a base object and different combinations of targeting parameter values is requested.

Storing natural language prompts requires less data than storing images, video, or other modalities of digital content that the system 100 can generate from the prompts. By storing the prompts, the system 100 can effectively compress the representation of corresponding digital content to a more compact text format. Further, multiple prompts with different combinations can be generated and stored to be retrieved, in place of storing their corresponding digital content equivalents, which even after compression may require megabytes or gigabytes of storage, instead of kilobytes by the individual prompts.

The engine 105 is also configured to determine whether an existing prompt stored in the repository 115 may be substituted in place of generating a new prompt, for different instances of base object descriptions and targeting parameter values. The engine 105 is configured to query the repository 115 for previously stored queries generated from data meeting a threshold of similarity with current base object descriptions and targeting parameter values. For example, the engine 105 can compare the differences in targeting parameter values between a currently received set of values, with sets of values used to generate previously stored prompts. If the difference is within a predetermined threshold, for example no more than one or two changes between the two sets, the engine 105 can retrieve the previously generated prompt and modify the prompt to reflect the updated parameter values.

Retrieving and modifying prompts instead of generating new prompts reduces redundant computation, at least because the system avoids generating multiple instances of the same prompt. Digital content delivery may be done in periodic flights, for example, because the same or similar content is delivered on a periodic basis to the same or different audiences. As a result, the system 100 will receive duplicates of the same base object description 130 or targeting parameter values 140. In examples in which the input is not identical, the engine 105 can still reduce redundant calculations by retrieving a stored prompt to act as a template and modifying the prompt accordingly. Reducing redundant calculations increases network efficiency by reducing the amount of processing power required to retrieve and/or generate a prompt.

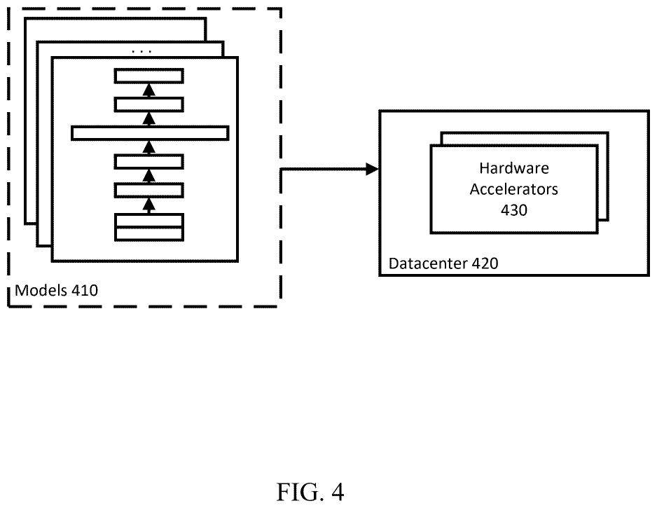

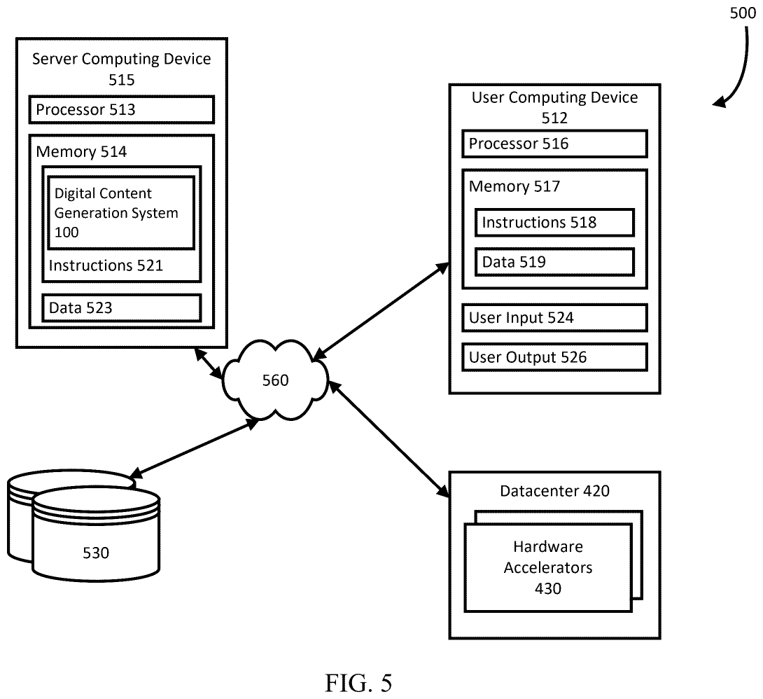

The generative model 110 is an AI model trained to receive prompts generated by the engine 105 and generate digital content. Digital content can be, for example, informative information, entertainment, advertisements, etc. For example, and as described also with reference to FIGS. 4 and 5, the generative model 110 can include one or more generative models, such as language models, foundation models, and/or graphical models. The generative model 110 may be trained to general digital content of different modalities, either as separate models or as one multimodal model. In examples in which the generative model 110 is trained to generate digital content from one or more different modalities, the generative model 110 receives input or some indication as to whether to generate digital content as a combination of text, image, video, etc.

The generative model 110 can implement one or more encoders and decoders for generating trained representations of input data and decoding the representations for generating new digital content. These representations can be discrete or continuous representations of input data, for example represented as vectors. The encoders can include transformers with self-attention mechanisms for encoding input data, which may be received by the model 110 as a series of tokens, frames, or other data units. The encoding layer of the model 110 can feed into an addition and normalization layer, and then further processed by a non-linear model, such as a neural network.

Decoders of the generative model 110 can receive and process the representation of the input data to obtain output corresponding to some digital content responsive to the input data. For generating images or video from text, the model 110 can encode a prompt using one or more trained text encoders. The model 110 can implement a diffusion-based model or other model technique for taking the text representation as input and generating a corresponding image or other digital content item responsive to the input. Diffusion models are a class of generative models that convert noise into samples from a learned data distribution. In general, any AI model technique for generating digital content from a text prompt may be used to implement the generative model 110. Details for training example models like the generative model 110 as described herein with reference to FIG. 4.

The generative model 110 can generate digital content items 170A, 170B, and 170C. The digital content items 170A-170C can be generated by processing prompts generated by the engine, using a base object description and different sets of targeting parameter values. For example, the generative model 110 can receive a prompt generated from the base object description 130 and targeting parameter values targeting an audience of which user computing device 180A. The model 110 processes this prompt to generate digital content item 170A. Similarly, other prompts with different targeting parameter values can be used to generate other content. These other prompts, when processed by the generative model 110, causes the generative model to generate digital content items 170B and 170C, for targeting user computing devices 180B and 180C, respectively.

The generative model 110 is configured to be able to deterministically generate the same output from a given input. For example, the model 110 may be trained using training data and an objective of reducing the computed error when the model 110 correctly generates the same output for multiple instances of the same input. In some examples, the system 100 implements a versioning system for the model 110. Each version of the model 110, for example represented by a respective set of hyperparameter and model parameter values, is saved to a log. The log may store differences between versions of the model 110. The model 110 can be further configured to receive a version number in addition to an input prompt, causing the model 110 to process the input prompt using the version of the model 110 corresponding to the version number.

In some examples, the model 110 can generate digital content for different combinations of targeting parameter values and the same base object description. The model 110 is trained to select one or some of the digital content items from the different digital content generated according to the different combinations.

In some examples, strictly identical output from the same input prompts is not necessary or desired. For example, as the model 110 is fine-tuned in later versions, how it decodes certain encoded representations of the input may change, for example, as a result of updated training examples used to train the model 110. As an example, the model 110 may receive updated training data corresponding to a geographic location. After fine-tuning the model 110 with the updated training data, the model 110 may generate new digital content as a result of the fine-tuning. Digital content generated between different versions of the model may still be targeted to the same audience, therefore, instead of saving an older version of content that may no longer be used, the system avoids the potential wasted storage by instead storing a prompt for generating digital content responsive to the target audience.

Although only three user computing devices 180A-C are shown in FIG. 1, in general thousands or more computing devices may be targeted for serving the digital content items 170A-C. Content serving may be performed automatically, for example in response to a request from the computing device for content. The platform 150 can determine devices that are to be targeted by different targeting parameter values, for example based on previous interaction with the devices, voluntary information provided from the device to the platform 150, or based on predictions as to whether the computing device is targeted by the parameter values used to generate the digital content item. In some examples, the device may not regularly interact with user input, but instead be deployed somewhere to output or display content at the deployed location, e.g., a metro transit station, a billboard, etc.

The digital content items 170A-170C can vary in style, format, or manner in which the base object is described or portrayed. The variations are due to how the model 110 is trained to generate digital content responsive to different audiences based on received targeting parameter values. For example, if prompts are generated with different values for geography as a targeting parameter, the digital content items 170A-C generated from the prompts can include depictions of the base object in or related to different geographic locations corresponding to the values. As another example, if prompts are generated with different values for content language as a targeting parameter, the digital content items 170A-C generated from the prompts can be written in different languages corresponding to the values.

The campaign management platform 150 can serve the digital content items 170A-C according to different flights. After a flight for a digital content item is over, the platform 150 stops serving the content to its target computing device. The digital content item can then be deleted, e.g., automatically by the platform 150 or in response to a command by the system 100. Thereafter, if the same digital content item is to be served to the same or similar target audience, the system 100 can retrieve the prompt corresponding to the content item, and re-process the prompt through the model 110. In this way, the system, inclusive of system 100 and platform 150, avoids the costly and inefficient storage of large items of multimedia content, and instead relies on a relatively smaller set of text prompts that can be used to retrieve the digital content item as needed. For example, storing text prompts requires kilobytes, instead of megabytes or gigabytes of larger multimedia content, such as images or video. Reducing the amount of storage required by the system increases the overall efficiency of the system, even in view of the processing power required by model 110.

### Example Methods

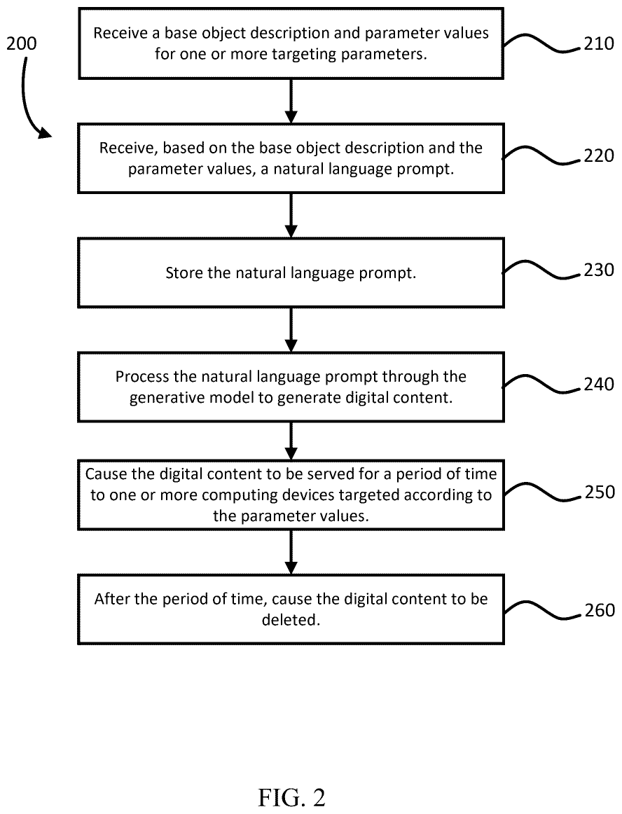

FIG. 2 depicts a flow diagram of an example process 200 for generating digital content, according to aspects of the disclosure. The example process can be performed on a system of one or more processors in one or more locations, such as the digital content generation system 100 of FIG. 1. The following operations do not have to be performed in the precise order described below. Rather, various operations can be handled in a different order or simultaneously, and operations may be added or omitted.

The system receives a base object description and parameter values for one or more targeting parameters, according to block 210. The system may include, for example, a digital content generation system, such as the system 100 described with reference to FIG. 1. The base object description and parameter values can be received from a campaign management platform, such as platform 150 described with reference to FIG. 1. In some examples, the system receives a subset of different combinations of values from one or more of the targeting parameters available on a campaign management platform.

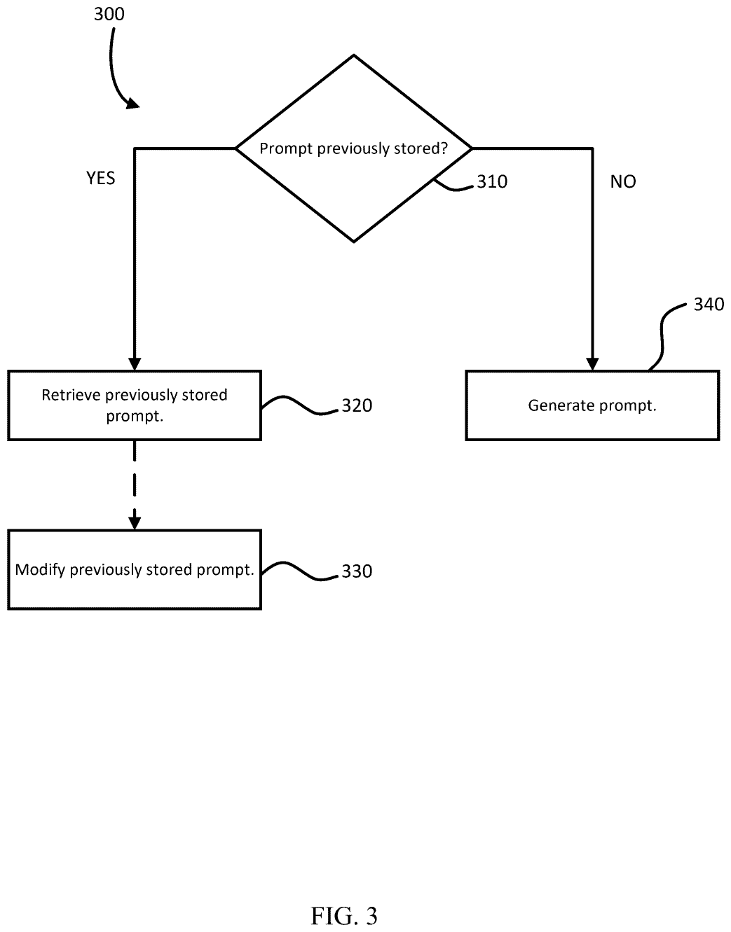

The system obtains, based on the base object description and the parameter values, a natural language prompt for a generative model trained to generate content from natural language prompts, according to block 220. The system can determine whether a previously generated prompt can be reused or modified for use, instead of generating a new prompt. For example, the system can apply the process 300 as shown and described with reference to FIG. 3.

The system stores the natural language prompt in one or more storage devices in communication with the one or more processors, according to block 230. For example, the system stores the prompt in a repository, which the system is configured to search according to an index. The index can include at least a portion of the base object description and/or the parameter values for the targeting parameters used. The system can store and later retrieve a prompt, instead of generating a new prompt. Further, the system can store the prompt for retrieving and re-generating digital content from the prompt, which requires less storage space overall versus storing the digital content directly.

As described above and with reference to FIG. 1, the system can generate, store, and later retrieve templates or portions of a prompt, in addition or as an alternative to storing entire prompts. The system can use the template or portion as input to the engine for generating a complete prompt, which may also include any additional input such a base object description and/or targeting parameter values not already represented in the template.

The system processes the natural language prompt through the generative model to generate digital content, according to block 240. The generative model is trained to receive a prompt containing natural language text and generate digital content according to one or more modalities. In some examples, the prompt can include data of other modalities besides text, such as images, videos, audio, or computer drawings or models of a base object.

The system can also receive additional input including criteria or limitations on digital content generated. For example, the input can include positive or negative keywords to include or exclude from the digital content. As another example, the input can specify the use or prohibition of certain backgrounds for the digital content. These criteria or conditions can be provided directly to the model through additional user input. These criteria or conditions can also be provided indirectly to the system through a corresponding set of targeting parameter values that result in the system generating content adhering to the provided criteria.

The system causes the digital content to be served for a period of time to one or more computing devices targeted according to the parameter values, according to block 250. The period of time corresponds to a flight for the digital content. The period of time for which the content is served can vary from example to example. For example, the period of time may just be as long as it takes to serve the content to a device once. In some examples, the period of time can be a day, a week, or longer or short periods. For example, the system may directly serve the digital content, for example by sending the digital content over a network to computing devices of the audience targeted by the targeting parameter values. In some examples, the system causes the digital content to be served by sending the digital content to a campaign management platform configured for serving the content to different computing devices.

The system causes, after the period of time, the digital content from the one or more storage devices to be deleted, according to block 260. Deleting or discarding the digital content avoids storing the digital content, which can be megabytes in size or larger, for text prompts, which can range from bytes to kilobytes of data. The deletion can be from some or all of the storage devices of the digital content generation system, the campaign management platform, or of other databases.

FIG. 3 depicts a flow diagram of an example process 300 for generating a prompt for a generative model trained to generate digital content, according to aspects of the disclosure. The example process can be performed on a system of one or more processors in one or more locations, such as the digital content generation system 100 of FIG. 1. The following operations do not have to be performed in the precise order described below. Rather, various operations can be handled in a different order or simultaneously, and operations may be added or omitted. Further, the system can perform the process independently or as part of the process 200, for example when receiving the natural language prompt, according to block 220 of FIG. 2.

The system determines whether a natural language prompt is stored that has been generated from a respective base object description and respective parameter values with a threshold measure of similarity to the received base object description and the parameter values, according to block 310. For example, the system compares a received set of targeting parameter values and a base object description with base object descriptions and targeting parameter values associated with a stored prompt. The comparison may be used to identify, or determine, any differences between the received set of targeting parameter values and the base object description and the base object descriptions and targeting parameter values associated with the stored prompt.

If the two sets of data match or are within a threshold measure of similarity, e.g., the same base object description, a predetermined number of matching parameter values, etc. then the system determines that there is a stored prompt within the threshold measure of similarity (“YES”). The system retrieves the stored natural language prompt, according to block 320. Even if the prompt retrieved is not identical to the prompt that the system would generate with the received base object description and targeting parameter values, the system can modify the previously stored prompt, if needed, according to block 330. Retrieving a prompt reduces the number of redundant computations performed by the system incurred by re-generating the prompt, even if some modifications are later made to the prompt. Reducing the number of redundant computations increases the overall efficiency of the system, even when there may be heavy processing requirements elsewhere, for example in processing or training the generative model.

If the system determines that there is not a stored prompt (“NO”), the system generates the natural language prompt, according to block 340. As described herein and with reference to FIGS. 1 and 2, after the system generates the prompt, the system stores the prompt such that the prompt can then be later retrieved instead of re-generating the prompt for generating the corresponding digital content.

Implementations of the present technology can each include, but are not limited to, the following. The features may be alone or in combination with one or more other features described herein. In some examples, the following features are included in combination:
(1) A method for serving digital content, including: receiving, by one or more processors, a base object description and parameter values for one or more targeting parameters;

obtaining, by the one or more processors, based on the base object description and the parameter values, a natural language prompt for a generative model trained to generate content from natural language prompts; storing, by the one or more processors, the natural language prompt in one or more storage devices in communication with the one or more processors; processing, by the one or more processors, the natural language prompt through the generative model to generate digital content; causing, by the one or more processors, the digital content to be served for a period of time to one or more computing devices targeted according to the parameter values; and after the period of time, causing, by the one or more processors, the digital content from the one or more storage devices to be deleted.
(2) The method of (1), wherein receiving the natural language prompt includes: determining, by the one or more processors, whether the one or more storage devices store a natural language prompt generated from a respective base object description and respective parameter values within a threshold measure of similarity to the base object description and the parameter values; and in response to determining that the one or more storage devices store the natural language prompt generated from the respective base object description and the respective parameter values, retrieving the natural language prompt from the one or more storage devices.
(3) The method of (1) or (2), further including identifying, by the one or more processors, differences between the base object description and the parameter values and the respective base object description and the respective parameter values used in generating the stored prompt.
(4) The method of (3), further including modifying, by the one or more processors, the retrieved natural language prompt in accordance with differences between the received base object description and the parameter values and the respective base object description and parameter values used to generate the received natural language prompt.
(5) The method of any one (1) through (4), wherein receiving the natural language prompt includes: determining, by the one or more processors, whether the one or more storage devices store a natural language prompt generated from a respective base object description and respective parameter values within a threshold measure of similarity to the base object description and the parameter values; and in response to determining that the one or more storage devices do not store the natural language prompt generated from the respective base object description and the respective parameter values, generating the natural language prompt from the base object description and the parameter values.
(6) The method of any one of (1) through (5), wherein the generative model is trained to generate the same output in response to the same input prompts.
(7) The method of any one of (1) through (6), wherein the base object description includes at least one of a name of the base object, a natural language description of the base object, or data modeling characteristics of the base object.
(8) The method of (7), wherein the base objection description includes data corresponding to one or more modalities, the one or more modalities including at least one of video, audio, image, text, or multi-dimensional model.
(9) The method of (8), wherein the generative model includes one or more modality-specific encoders for encoding data including multiple modalities.
(10) A system including: one or more processors configured to perform the method as in any one of (1) through (8).
(11) One or more non-transitory computer-readable media, encoding instructions that when performed by one or more processors cause the one or more processors to perform operations as in any one of (1) through (9).
(12) The one or more computer-readable media of (11), wherein the one or more computer-readable media are non-transitory.

### Example Computing Environment

FIG. 4 is a block diagram illustrating one or more models 410, such as for deployment in a datacenter 420 housing one or more hardware accelerators 430 on which the deployed models will execute for generating digital content according to prompts generated and stored in accordance with aspects of the disclosure. The hardware accelerators 430 can be any type of processor, such as a central processing unit (CPU), graphics processing unit (GPU), field-programmable gate array (FPGA), or an application-specific integrated circuit (ASIC), such as a tensor processing unit (TPU).

In some implementations, the techniques disclosed herein generate digital content from prompts generated and stored according to aspects of the disclosure, using artificial intelligence. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pre-trained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

An architecture of a model can refer to characteristics defining the model, such as characteristics of layers for the model, how the layers process input, or how the layers interact with one another. For example, the model can be a convolutional neural network that includes a convolution layer that receives input data, followed by a pooling layer, followed by a fully connected layer that generates a result. The architecture of the model can also define types of operations performed within each layer. For example, the architecture of a convolutional neural network may define that rectified linear unit (ReLU) activation functions are used in the fully connected layer of the network. Other example architectures can include generative models, such as language models, foundation models, and/or graphical models. One or more model architectures can be generated that can output results associated with generating digital content from prompts generated or stored by the system 100.

As another example, with respect to reinforcement learning, situations encountered by an agent, e.g., a model, a computing device, a system, a robot, etc., are mapped to actions taken by the agent in those situations to maximize the reward or value of its actions. The agent can interact with an environment through its actions. At any given time or point at which the agent is able to act, the environment can be represented as a state. The state can include any information or features about the environment that can be known by the agent. The value of a state is a measure of the total amount of reward the agent can receive from the current state and future states accessible from the current state. A value function can be defined or estimated for calculating, predicting, or estimating the value of a state. Techniques for training a machine learning model via reinforcement learning can focus on estimating or learning value functions to accurately predict value across different states of an environment.

The model or policy can be modified or updated until stopping criteria are met, such as a number of iterations for training, a maximum period of time, a convergence of estimated rewards or value between actions, or when a minimum value threshold is met. A model can be a composite of multiple models or components of a processing or training pipeline. In some examples, the models or components are trained separately, while in other examples, the models or components are trained end-to-end.

FIG. 5 is a block diagram of an example computing environment 500 for implementing the digital content generation system 100. The system 100 can be implemented on one or more devices having one or more processors in one or more locations, such as in server computing device 515. User computing device 512 and the server computing device 515 can be communicatively coupled to one or more storage devices 530 over a network 560. The storage device(s) 530 can be a combination of volatile and non-volatile memory and can be at the same or different physical locations than the computing devices 512, 515. For example, the storage device(s) 530 can include any type of non-transitory computer readable medium capable of storing information, such as a hard-drive, solid state drive, tape drive, optical storage, memory card, ROM, RAM, DVD, CD-ROM, write-capable, and read-only memories.

Aspects of the disclosure can be implemented in a computing system that includes a back-end component, e.g., as a data server, a middleware component, e.g., an application server, or a front-end component, e.g., user computing device 512 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet. The datacenter 420 can also be in communication with the user computing device 512 and the server computing device 515.

The computing system can include clients, e.g., user computing device 512 and servers, e.g., server computing device 515. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

The server computing device 515 can include one or more processors 513 and memory 514. The memory 514 can store information accessible by the processor(s) 513, including instructions 521 that can be executed by the processor(s) 513. The memory 514 can also include data 523 that can be retrieved, manipulated, or stored by the processor(s) 513. The memory 514 can be a type of non-transitory computer readable medium capable of storing information accessible by the processor(s) 513, such as volatile and non-volatile memory. The processor(s) 513 can include one or more central processing units (CPUs), graphic processing units (GPUs), field-programmable gate arrays (FPGAs), and/or application-specific integrated circuits (ASICs), such as tensor processing units (TPUs).

The instructions 521 can include one or more instructions that when executed by the processor(s) 513, causes the one or more processors to perform actions defined by the instructions. The instructions 521 can be stored in object code format for direct processing by the processor(s) 513, or in other formats including interpretable scripts or collections of independent source code modules that are interpreted on demand or compiled in advance. The instructions 521 can include instructions for implementing the system 100 consistent with aspects of this disclosure. The system 100 can be executed using the processor(s) 513, and/or using other processors remotely located from the server computing device 515.

The data 523 can be retrieved, stored, or modified by the processor(s) 513 in accordance with the instructions 521. The data 523 can be stored in computer registers, in a relational or non-relational database as a table having a plurality of different fields and records, or as JSON, YAML, proto, or XML documents. The data 523 can also be formatted in a computer-readable format such as, but not limited to, binary values, ASCII, or Unicode. Moreover, the data 523 can include information sufficient to identify relevant information, such as numbers, descriptive text, proprietary codes, pointers, references to data stored in other memories, including other network locations, or information that is used by a function to calculate relevant data.

The user computing device 512 can also be configured similar to the server computing device 515, with one or more processors 516, memory 517, instructions 518, and data 519. For example, the user computing device 512 can be a mobile device, a laptop, a desktop computer, a game console, etc. The user computing device 512 can also include a user output 526, and a user input 524. The user input 524 can include any appropriate mechanism or technique for receiving input from a user, including acoustic input; visual input; tactile input, including touch motion or gestures, or kinetic motion or gestures or orientation motion or gestures; auditory input, speech input, etc., Example devices for user input 524 can include a keyboard, mouse or other point device, mechanical actuators, soft actuators, touchscreens, microphones, and sensors.

The server computing device 515 can be configured to transmit data to the user computing device 512, and the user computing device 512 can be configured to display at least a portion of the received data on a display implemented as part of the user output 526. The user output 526 can also be used for displaying an interface between the user computing device 512 and the server computing device 515. The user output 526 can alternatively or additionally include one or more speakers, transducers or other audio outputs, a haptic interface or other tactile feedback that provides non-visual and non-audible information to the platform user of the user computing device 512.

Although FIG. 5 illustrates the processors 513, 516 and the memories 514, 517 as being within the computing devices 515, 512, components described in this specification, including the processors 513, 516 and the memories 514, 517 can include multiple processors and memories that can operate in different physical locations and not within the same computing device. For example, some of the instructions 521, 518 and the data 523, 519 can be stored on a removable SD card and others within a read-only computer chip. Some or all of the instructions and data can be stored in a location physically remote from, yet still accessible by, the processors 513, 516. Similarly, the processors 513, 516 can include a collection of processors that can perform concurrent and/or sequential operation. The computing devices 515, 512 can each include one or more internal clocks providing timing information, which can be used for time measurement for operations and programs run by the computing devices 515, 512.

The server computing device 515 can be configured to receive requests to process data from the user computing device 512. For example, the environment 500 can be part of a computing platform configured to provide a variety of services to users, through various user interfaces and/or APIs exposing the platform services. One or more services can be a machine learning framework or a set of tools for training or executing generative models or other machine learning models according to a specified task and training data.

The devices 512, 515 can be capable of direct and indirect communication over the network 560. The devices 515, 512 can set up listening sockets that may accept an initiating connection for sending and receiving information. The network 560 itself can include various configurations and protocols including the Internet, World Wide Web, intranets, virtual private networks, wide area networks, local networks, and private networks using communication protocols proprietary to one or more companies. The network 560 can support a variety of short-and long-range connections. The short-and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 560, in addition or alternatively, can also support wired connections between the devices 512, 515, including over various types of Ethernet connection.

Although a single server computing device 515, user computing device 512, and datacenter 420 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more engines or modules of computer program instructions encoded on one or more tangible non-transitory computer storage media for execution by, or to control the operation of, one or more data processing apparatus.

A computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus. A computer program may, but need not, correspond to a file in a file system. A computer program can be stored in a portion of a file that holds other programs or data, e.g., one or more scripts, in a single file, or in multiple coordinated files, e.g., files that store one or more engines, modules, sub-programs, or portions of code.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” can refer to a software-based system, subsystem, or process that is programmed to perform one or more specific functions. The engine can be implemented as one or more software modules or components or can be installed on one or more computers in one or more locations. A particular engine can have one or more processors or computing devices dedicated thereto, or multiple engines can be installed and running on the same processor or computing device. In some examples, an engine can be implemented as a specially configured circuit, while in other examples, an engine can be implemented in a combination of software and hardware.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers. While operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all examples, and it should be understood that the described program components and systems can be integrated together in one or more software or hardware-based devices or computer-readable media.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, desktop computer, a personal digital assistant (PDA), a mobile audio or video player, a game console, a tablet, a virtual-reality (VR) or augmented-reality (AR) device, a Global Positioning System (GPS), or a portable storage device, e.g., a universal serial bus (USB) flash drive, as examples. Examples of the computer or special purpose logic circuitry can include the user computing device 512, the server computing device 515, or the hardware accelerators 430.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

1. A method for serving digital content, comprising:
receiving, by one or more processors, a base object description and parameter values for one or more targeting parameters;
obtaining, by the one or more processors, based on the base object description and the parameter values, a natural language prompt for a generative model trained to generate content from natural language prompts;
storing, by the one or more processors, the natural language prompt in one or more storage devices in communication with the one or more processors;
processing, by the one or more processors, the natural language prompt through the generative model to generate digital content;
causing, by the one or more processors, the digital content to be served for a period of time to one or more computing devices targeted according to the parameter values; and
after the period of time, causing, by the one or more processors, the digital content from the one or more storage devices to be deleted.

2. The method of claim 1, wherein receiving the natural language prompt comprises:
determining, by the one or more processors, whether the one or more storage devices store a natural language prompt generated from a respective base object description and respective parameter values within a threshold measure of similarity to the base object description and the parameter values; and
in response to determining that the one or more storage devices store the natural language prompt generated from the respective base object description and the respective parameter values, retrieving the natural language prompt from the one or more storage devices.

3. The method of claim 1, further comprising identifying, by the one or more processors, differences between (i) the base object description and the parameter values and (ii) the respective base object description and the respective parameter values used in generating the stored natural language prompt.

4. The method of claim 3, further comprising modifying, by the one or more processors, the retrieved natural language prompt in accordance with the identified differences between the received base object description and the parameter values and the respective base object description and parameter values used to generate the received natural language prompt.

5. The method of claim 1 wherein receiving the natural language prompt comprises:
determining, by the one or more processors, whether the one or more storage devices store a natural language prompt generated from a respective base object description and respective parameter values within a threshold measure of similarity to the base object description and the parameter values; and
in response to determining that the one or more storage devices do not store the natural language prompt generated from the respective base object description and the respective parameter values, generating the natural language prompt from the base object description and the parameter values.

6. The method of claim 1, wherein the generative model is trained to generate the same output in response to the same input prompts.

7. The method of claim 1, wherein the base object description comprises at least one of a name of the base object, a natural language description of the base object, or data modeling characteristics of the base object.

8. The method of claim 7, wherein the base objection description comprises data corresponding to one or more modalities, the one or more modalities comprising at least one of video, audio, image, text, or multi-dimensional model.

9. The method of claim 8, wherein the generative model comprises one or more modality-specific encoders for encoding data comprising multiple modalities.

10. A system, comprising:
one or more processors configured to:
receive a base object description and parameter values for one or more targeting parameters;
obtain, based on the base object description and the parameter values, a natural language prompt for a generative model trained to generate content from natural language prompts;
store the natural language prompt in one or more storage devices in communication with the one or more processors;
process the natural language prompt through the generative model to generate digital content;
cause the digital content to be served for a period of time to one or more computing devices targeted according to the parameter values; and
after the period of time, cause the digital content from the one or more storage devices to be deleted.

11. The system of claim 10, wherein in receiving the natural language prompt, the one or more processors are configured to:
determine whether the one or more storage devices store a natural language prompt generated from a respective base object description and respective parameter values within a threshold measure of similarity to the base object description and the parameter values; and
in response to the determination that the one or more storage devices store the natural language prompt generated from the respective base object description and the respective parameter values, retrieve the natural language prompt from the one or more storage devices.

12. The system of claim 10, wherein the one or more processors are further configured to identify differences between the base object description and the parameter values and the respective base object description and the respective parameter values used in generating the stored prompt.

13. The system of claim 12, wherein the one or more processors are further configured to modify the retrieved natural language prompt in accordance with differences between the received base object description and the parameter values and the respective base object description and parameter values used to generate the received natural language prompt.

14. The system of claim 10, wherein in receiving the natural language prompt, the one or more processors are configured to:
determine whether the one or more storage devices store a natural language prompt generated from a respective base object description and respective parameter values within a threshold measure of similarity to the base object description and the parameter values; and
in response to the determination that the one or more storage devices do not store the natural language prompt generated from the respective base object description and the respective parameter values, generate the natural language prompt from the base object description and the parameter values.

15. The system of claim 10, wherein the generative model is trained to generate the same output in response to the same input prompts.

16. The system of claim 10, wherein the base object description comprises at least one of a name of the base object, a natural language description of the base object, or data modeling characteristics of the base object.

17. The system of claim 16, wherein the base objection description comprises data corresponding to one or more modalities, the one or more modalities comprising at least one of video, audio, image, text, or multi-dimensional model.

18. The system of claim 17, wherein the generative model comprises one or more modality-specific encoders for encoding data comprising multiple modalities.

19. One or more non-transitory computer readable storage media, encoding instructions that when performed by one or more processors, cause the one or more processors to perform operations comprising:
receiving a base object description and parameter values for one or more targeting parameters;
obtain, based on the base object description and the parameter values, a natural language prompt for a generative model trained to generate content from natural language prompts;
storing the natural language prompt in one or more storage devices in communication with the one or more processors;
processing the natural language prompt through the generative model to generate digital content;
causing the digital content to be served for a period of time to one or more computing devices targeted according to the parameter values; and
after the period of time, causing the digital content from the one or more storage devices to be deleted.

20. The computer-readable storage media of claim 19, wherein receiving the natural language prompt comprises:
determining whether the one or more storage devices store a natural language prompt generated from a respective base object description and respective parameter values within a threshold measure of similarity to the base object description and the parameter values; and
in response to determining that the one or more storage devices store the natural language prompt generated from the respective base object description and the respective parameter values, retrieving the natural language prompt from the one or more storage devices.
